(19) United States
(12) Patent Application Publication
(10) Pub. No.: US 2009/0104505 A1
(43) Pub. Date: Apr. 23, 2009

(54) STRUCTURE OF A FUEL CELL STACK

(75) Inventors: Tsang-Ming Chang, Taipei City (TW); Feng-Yi Deng, Taipei City (TW); Ming-Huang Tsai, Taipei City (TW); Chia-Hao Chang, Taipei City (TW); Ting-Yi Yu, Taipei City (TW)

Correspondence Address: APEX JURIS, PLLC, 12733 LAKE CITY WAY NORTHEAST, SEATTLE, WA, 98125, US

(73) Assignee: ANTIG TECHNOLOGY CORPORATION, Grand Cayman (GB)

(21) Appl. No.: 12/253,220

(22) Filed: Oct. 16, 2008

(30) Foreign Application Priority Data
Oct. 17, 2007 (CN) 200710163217.4

(51) Int. Cl. H01M 2/02

(52) U.S. Cl. 429/34

(57) ABSTRACT

A structure of a fuel cell stack is disclosed in the present invention, comprising: a first cathode plate; a first fuel cell module; an anode channel plate; a second fuel cell module; and a second cathode plate stacked from top to bottom. Each of the fuel cell modules respectively includes: a cathode collector sheet; at least more than one membrane electrode assembly; an adhesive strip having at least one receiving space for respectively receiving the membrane electrode assemblies; a positioning plate having at least more than one receiving space; at least more than one collector sheet being respectively disposed in the receiving space of the positioning plate.

### FIELD OF THE INVENTION

The present invention relates to a structure of a fuel cell stack, and more particularly to a structure of a fuel cell stack that may be easily assembled.

### BACKGROUND OF THE INVENTION

In the U.S. Patent publication No. US20,060,051,626A1 with the title of “Fuel Cell Stack” published earlier, a structure of a fuel cell stack has already been disclosed; whereas other types of fuel cell stack structure have also been disclosed in U.S. Patent publication No. US20,050,074,652A1 with the title of “Direct Liquid Feed Fuel Cell Stack”, as well as in U.S. Patent publication No. US20,050,042,493A1 titled “Fuel Cell Device”. It can be said that the aforesaid three types of fuel cell stack structure have facilitated better understanding about the fuel cell stacks for developers thereof.

However, in light of disadvantages found in conventional structures of the fuel cell stack, the inventor of the present invention has proposed a structure of a fuel cell stack that may be easily assembled.

### SUMMARY OF THE INVENTION

A primary objective of the invention is to propose a structure of a fuel cell stack that may be easily assembled.

To achieve the above objective, a structure of a fuel cell stack disclosed in the invention comprises: a first cathode plate, a first fuel cell module, an anode channel plate, a second fuel cell module, and a second cathode plate stacked from top to bottom; wherein the first and the second fuel cell modules are structurally identical, and each of the fuel cell modules respectively includes: a cathode collector sheet, at least more than one membrane electrode assembly, an adhesive strip having at least one receiving space for respectively receiving the membrane electrode assemblies, a positioning plate having at least more than one receiving space, at least more than one collector sheet being respectively disposed in the receiving space of the positioning plate; in which the cathode collector sheet and the positioning plate are held together by using the adhesive strip, and the membrane electrode assemblies is sandwiched between the cathode collector sheet and the positioning plate, wherein the first and the second cathode plates are structurally identical, and cathode channels facing a first direction are disposed on internal surfaces of both of the cathode plates, while anode channels facing a second direction are disposed on two opposing surfaces of the anode channel plate; the cathode channels facing the first direction on the first and the second cathode plates are perpendicular to the anode channels facing the second direction on the anode channel plate.

### BRIEF DESCRIPTION OF DRAWINGS

The structure and the technical means adopted by the present invention to achieve the above objective can be best understood by referring to the following detailed description of the preferred embodiments and the accompanying drawings, wherein:

FIG. 1 is a schematic view that shows a structure of a fuel cell stack made up of structures from FIGS. 2A and 2B according to the present invention;

FIG. 2A is a disassembled view that shows a first portion of a fuel cell stack according to the present invention.;

FIG. 2B is a disassembled view that shows a second portion of a fuel cell stack according to the present invention;

FIG. 3 is an assembled view that shows a fuel cell stack according to the present invention;

FIG. 4 is a schematic view that shows a fuel cell stack having a first type of a mask and a fan according to the present invention; and

FIG. 5 is a schematic view that shows a fuel cell stack having a second type of a mask and a fan according to the present invention.

### DETAILED DESCRIPTION OF THE INVENTION

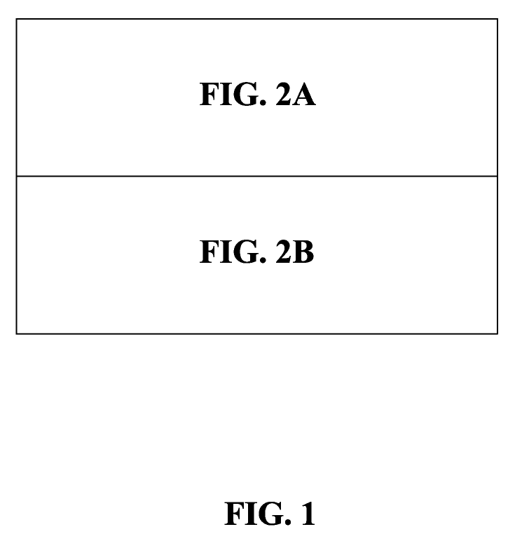

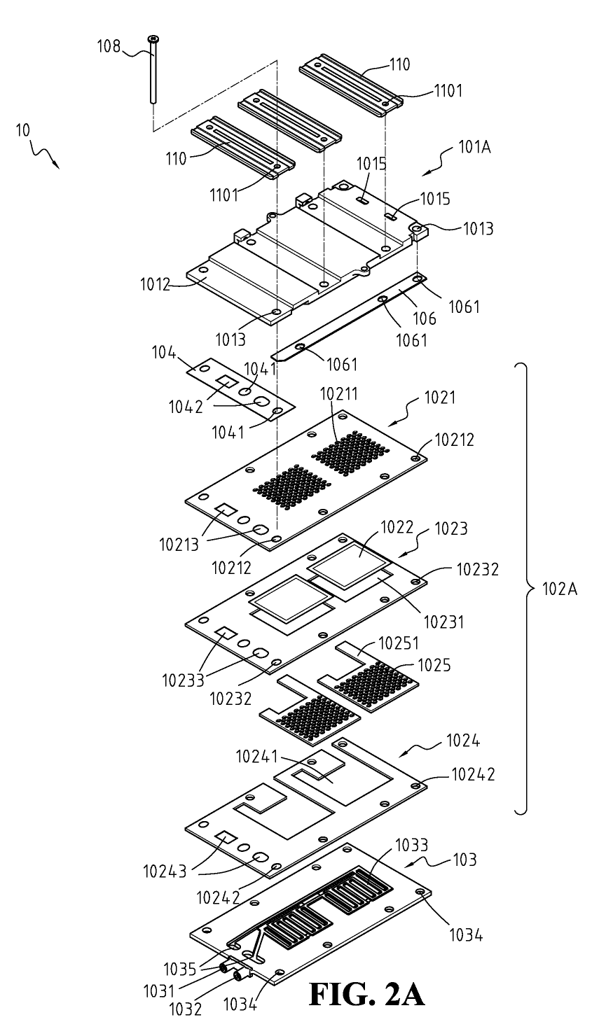

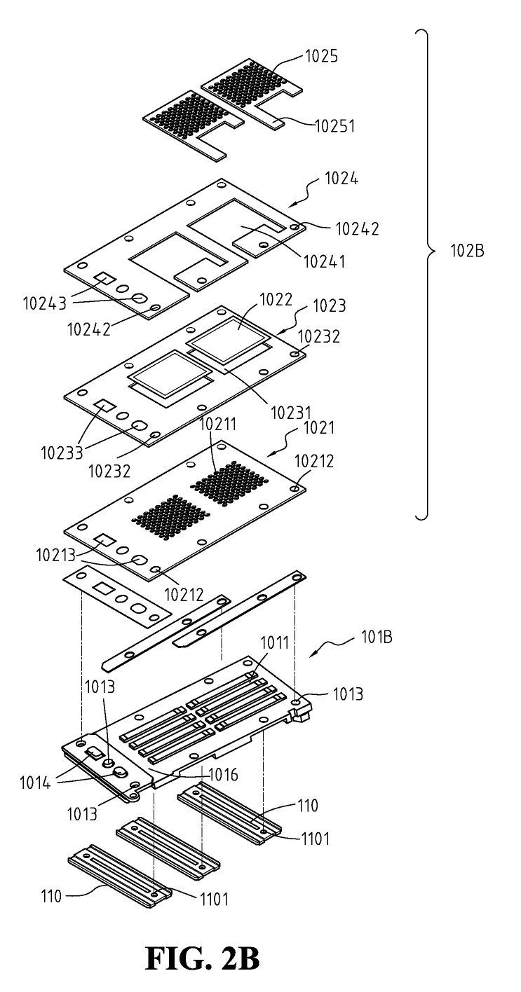

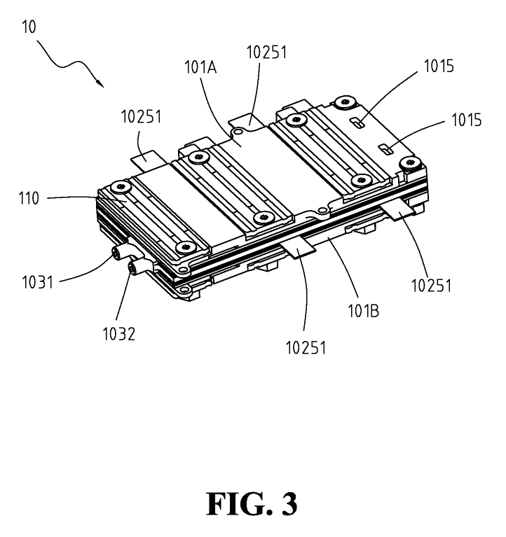

FIG. 1 is a schematic view that shows a structure of a fuel cell stack made up of structures from FIGS. 2A and 2B according to the present invention; FIG. 2A is a disassembled view that shows a first portion of a fuel cell stack according to the present invention, while FIG. 2B is a disassembled view that shows a second portion of a fuel cell stack according to the present invention, and FIG. 3 is an assembled view that shows a fuel cell stack according to the present invention. FIGS. 1-3 show that a fuel cell stack 10 proposed in the invention mainly comprises a first cathode plate 101A, a first fuel cell module 102A, a first anode channel plate 103, a second fuel cell module 102B, and a second cathode plate 101B; the aforesaid components will be described in further details hereafter.

The first fuel cell module 102A and the second fuel cell module 102B are structurally identical, and the fuel cell modules 102A and 102B each includes: a cathode current collector sheet 1021, at least more than one membrane electrode assembly 1022, an adhesive strip 1023, a positioning plate 1024, and at least more than one current collector sheet 1025.

The cathode current collector sheet 1021 has a plurality of through openings 10211 disposed thereon, as well as screw holes 10212 and openings 10213 peripherally disposed thereon. The openings 10211 are used to allow cathode fuels and cathode products to pass through. The cathode current collector sheet 1021 may be made from materials selected from one of the following categories: resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit substrates.

The membrane electrode assembly 1022 may be implemented by using prior arts of this field. For example, a direct methanol fuel cell having membrane electrode assemblies made of proton exchange membranes may be employed.

The adhesive strip 1023 has at least one receiving space 10231 for respectively receiving the membrane electrode assemblies 1022. In addition, the adhesive strip 1023 also has screw holes 10232 and openings 10233 peripherally disposed thereon, and may be made of PP adhesives.

The positioning plate 1024 has at least one receiving space 10241 for receiving the current collector sheet 1025. The positioning plate 1024 also has screw holes 10242 and openings 10243 peripherally disposed thereon, and may be made from materials selected from one of the following categories: resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit substrates.

The current collector sheet 1025 may include an outwardly-extending plate 10251 disposed thereon, and the plate 10251 mainly serves as a point of electrical connection in either serial-connections or parallel-connections of the membrane electrode assemblies 1022. The current collector sheet 1025 includes a plurality of openings thereon, and the openings are used to allow anode fuels and anode products to pass through. The current collector sheet 1025 may be made from conductive materials, and is preferably made from resistant materials that have anti-corrosive and/or anti-acidic properties. For instance, the materials may be selected from one of the following categories: stainless steel plates (SUS316), gold foils, titanium metal, graphite material, carbon-metal compounds material, metal alloy plates, and polymer conductive pads with low electrical resistance.

The anode channel plate 103 further includes an anode fuel inlet 1031 and an anode fuel outlet 1032 disposed thereon. The anode fuel inlet 1031 and the anode fuel outlet 1032 serve as a sole entry/exit for anode fuels for the fuel cell stack 10. The anode channel plate 103 is a dual-surface anode channel plate, which includes two opposing surfaces having anode channels 1033 facing a second direction. For example, the anode channels 1033 may be disposed vertically. The anode channel plate 103 has screw holes 1034 and openings 1035 peripherally disposed thereon, and may be made from materials selected from one of the following categories: resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit substrates.

The first cathode plate 101A and the second cathode plate 101B are structurally identical, which are both single-surface cathode plates, respectively. The cathode plates 101A and 101B each comprises cathode channels 1011 facing a first direction disposed on an internal surface thereof. For example, the cathode channels 1011 may be disposed horizontally. The cathode plates 101A and 101B each comprises at least one recess 1012 disposed on an external surface thereof. In addition, the cathode plates 101A and 101B each includes screw holes 1013, protruding caps 1014, and recessed holes 1015 peripherally disposed thereon. Moreover, grooves 1016 are disposed between the cathode channels 1011 and the screw holes 1013, as well as the protruding caps 1014. The first cathode plate 101A and the second cathode plate 101B may be made from materials selected from one of the following categories: resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit substrates.

In this invention, the cathode channels 1011 of the first cathode plate 101A and the second cathode plate 101B that face the first direction are perpendicular to the anode channels 1033 of the anode channel plate 103 that face the second direction.

A first pad 104 has at least three screw holes 1041 and two openings 1042 disposed thereon, and the screw holes 1041 and openings 1042 correspond to screw holes 1054 and openings 1055 disposed on a cathode channel plate 105, and to the screw holes 1013 and protruding caps 1014 of the first cathode plate 101A and the second cathode plate 101B as well.

A second pad 106 has at least three screw holes 1061 disposed thereon, and the screw holes 1061 correspond to the screw holes 1054 of the cathode channel plate 105, and to the screw holes 1013 of the first cathode plate 101A and the second cathode plate 101B as well.

The first pad 104 and the second pad 106 may be made of rubber.

A bearing plate 110 has at least two screw holes 1101 disposed thereon, and the screw holes 1101 correspond to the screw holes 1013 of the first cathode plate 101A and the second cathode plate 101B. The bearing plate 110 may be made of hard metals.

With regard to assembling the fuel cell stack 10 of the invention, firstly adhere two pieces of the positioning plates 1024 onto the two opposing external surfaces of the anode channel plate 103, respectively, and then separately place four pieces of the current collector sheets 1025 into the receiving spaces 10241 of the two positioning plates 1024.

Subsequently, adhere two of the adhesive strips 1023 onto the external surfaces of the two positioning plates 1024, such that the current collector sheets 1025 are sandwiched between the positioning plates 1024 and the adhesive strips 1023. Next, separately place four pieces of the membrane electrode assemblies 1022 into the two receiving spaces 10231 of the two adhesive strips 1023, such that each of the current collector sheets 1025 comes into contact with an anode and a cathode from each of the four membrane electrode assemblies 1022, thereby forming anode collector sheets and cathode current collector sheets; while allowing the plates 10251 of the current collector sheets 1025 to extend out of the two positioning plates 1024.

This is followed by adhering two pieces of the cathode current collector sheets 1021 onto the external surfaces of the two adhesive strips 1023, so as to sandwich the four membrane electrode assemblies 1022 between the positioning plates 1024 and the adhesive strips 1023. Afterwards, two pieces of the first pads 104 and four pieces of the second pads 106 are separately adhered onto the internal surfaces of the first cathode plate 101A and the second cathode plate 101B, while three pieces of the bearing plates 110 are separately adhered onto the recesses 1012 on the external surfaces of the first cathode plate 101A and the second cathode plate 101B. Subsequently, the first cathode plate 101A and the second cathode plate 101B are separately adhered onto the external surfaces of the two cathode current collector sheets 1021, so that the first pads 104 and the second pads 106 are sandwiched between the first cathode plate 101A and the second cathode plate 101B.

Finally, a plurality of screws 108 are inserted into the fuel cell stack 10, which go through the aforesaid components in the following order: the first cathode plate 101A, the first fuel cell module 102A, the anode channel plate 103, the second fuel cell module 102B, the second cathode plate 101B, and the screw holes of a plurality of the first pads 104, the second pads 106, and the bearing plates 110, thereby completing the assembly of the fuel cell stack 10 according to the invention.

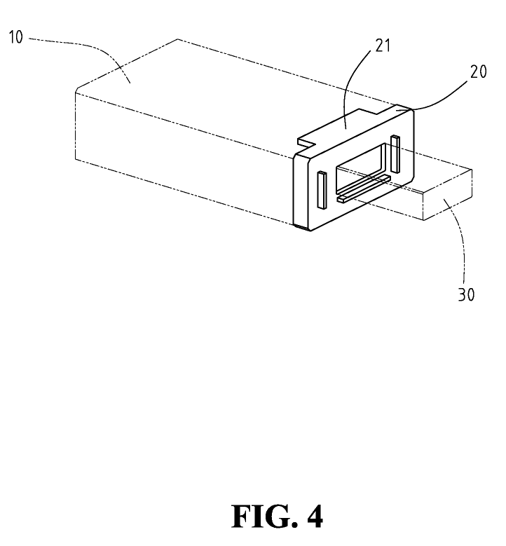

As shown in FIG. 4, a first mask 20 of the invention includes corresponding fastening portions 21 at two sides thereof, and the first mask 20 is fastened into the recessed holes 1015 of the first cathode plate 101A and the second cathode plate 101B at two opposing external sides of the fuel cell stack 10 by using the fastening portions 21, so as to combine the first mask 20 and the fuel cell stack 10 together. Furthermore, a first fan 30 may also be combined with the first mask 20.

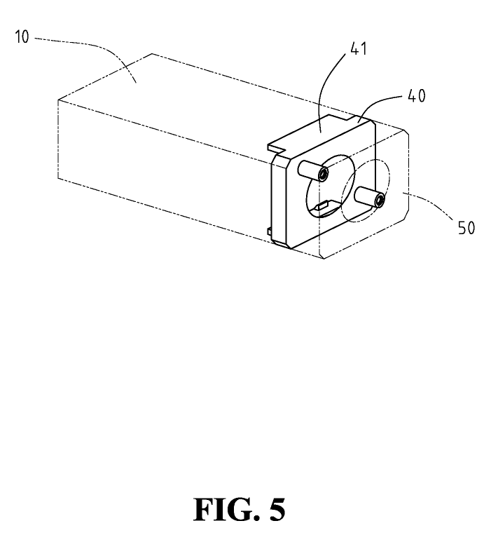

As shown in FIG. 5, a second mask 40 of the invention includes corresponding fastening portions 41 at two sides thereof, and the second mask 40 is fastened into the recessed holes 1015 of the first cathode plate 101A and the second cathode plate 101B at two opposing external sides of the fuel cell stack 10 by using the fastening portions 41, so as to combine the second mask 40 and the fuel cell stack 10 together. Furthermore, a second fan 50 may also be combined with the second mask 40.

The first fan 30 and the second fan 50 may be selected from blowers and bladed fans, for instance. The fans are mainly used to provide propulsion required for allowing gases to flow, so as to allow external air and cathode products to flow within the fuel cell stack 10.

In the aforesaid embodiment, the openings 1042, 10213, 10243, and 1035 serve as channels for anode fuels and anode products to flow through. The protruding caps 1014 are used to seal off the openings 1042 located on two outer-most lateral sides of the fuel cell stack 10.

In the aforesaid embodiment, the grooves 1016 at least serve as channels for cathode fuels to flow through.

The fuel cell stack 10 of the invention can be assembled easily, which is the main advantage and benefit of the present invention.

The present invention has been described with a preferred embodiment thereof that is not used to limit the scope of the invention. Those skilled in the art should understood that many changes and modifications to the described embodiment can be carried out without departing from the scope and the spirit of the invention.

What is claimed is:

1. A structure of a fuel cell stack; comprising: a first cathode plate (101A); a first fuel cell module (102A); an anode channel plate (103); a second fuel cell module (102B); and a second cathode plate (101B) stacked from top to bottom;
wherein the first fuel cell module (102A) and the second fuel cell module (102B) are structurally identical, and each of the fuel cell modules (102A), (102B) respectively includes:
a cathode current collector sheet (1021);
at least more than one membrane electrode assembly (1022);
an adhesive strip (1023) having at least one receiving space for respectively receiving said membrane electrode assemblies;
a positioning plate (1024) having at least more than one receiving space;
at least more than one current collector sheet (1025) being respectively disposed in the receiving space of said positioning plate;
wherein said cathode current collector sheet (1021) and said positioning plate (1024) are held together by using said adhesive strip (1023), and said membrane electrode assemblies (1022) are sandwiched between said cathode current collector sheet (1021) and said positioning plate (1024);
wherein the first cathode plate (101A) and the second cathode plate (101B) are structurally identical, and cathode channels facing a first direction are disposed on internal surfaces of each of the cathode plates (101A), (101B);
wherein anode channels facing a second direction are disposed on two opposing surfaces of said anode channel plate (103);
wherein said first direction is perpendicular to said second direction.

2. The structure of the fuel cell stack of claim 1, wherein the cathode current collector sheets of said first and second fuel cell modules (102A), (102B) are respectively disposed with a plurality of through openings.

3. The structure of the fuel cell stack of claim 1, wherein said anode channel plate (103), said cathode current collector sheet (1021), said adhesive strip (1023), and said positioning plate (1024) are respectively and correspondingly disposed with a plurality of openings and screw holes.

4. The structure of the fuel cell stack of claim 1, wherein said first cathode plate (101A) and said second cathode plate (101B) are respectively disposed with a plurality of protruding caps and screw holes on internal surfaces thereof.

5. The structure of the fuel cell stack of claim 1, wherein said first cathode plate (101A) and said second cathode plate (101B) are respectively disposed with a plurality of recesses (1012) on external surfaces thereof.

6. The structure of the fuel cell stack of claim 1, further comprising: a plurality of first pads (104) and a plurality of second pads (106).

7. The structure of the fuel cell stack of claim 6, wherein said first pads (104) and said second pads (106) are made of rubber.

8. The structure of the fuel cell stack of claim 1, further comprising: a plurality of bearing plates (110).

9. The structure of the fuel cell stack of claim 8, wherein said bearing plates are made of hard metals.

10. The structure of the fuel cell stack of claim 1, wherein said adhesive strip (1023) is made of PP adhesives.

11. The structure of the fuel cell stack of claim 1, wherein said first cathode plate (101A), said second cathode plate (101B), said positioning plate (1024), and said anode channel plate (103) may be made from materials selected from one of the following categories: resistant and non-conductive engineering plastic substrates, carbon-reinforced plastic substrates, FR4 substrates, FR5 substrates, epoxy resin substrates, fiber glass substrates, ceramic substrates, polymer plastic substrates, composite substrates, and printed circuit substrates.

12. The structure of the fuel cell stack of claim 1, wherein said current collector sheet (1025) may include outwardly-extending plates (10251) disposed thereon.

13. The structure of the fuel cell stack of claim 1, further comprising a first mask (20) for combining with a first fan (30).

14. The structure of the fuel cell stack of claim 1, further comprising a second mask (40) for combining with a second fan (50).

15. The structure of the fuel cell stack of claim 1, wherein the cathode channels of said first cathode plate (101A) and said second cathode plate (101B) are horizontally disposed.

16. The structure of the fuel cell stack of claim 1, wherein the anode channels of said anode channel plate (103) are vertically disposed.
